(19) United States
(12) Patent Application Publication
(10) Pub. No.: US 2003/0052457 A1
(43) Pub. Date: Mar. 20, 2003

(54) Pressure actuated snout sealing system for steam turbines

(76) Inventors: Norman Arnold Turnquist, Sloansville, NY (US); Wei-Ming Chi, Sunnyvale, CA (US)

Correspondence Address: GENERAL ELECTRIC COMPANY, GLOBAL RESEARCH CENTER, PATENT DOCKET RM. 4A59, PO BOX 8, BLDG. K-1 ROSS, NISKAYUNA, NY, 12309, US

(21) Appl. No.: 09/682,561

(22) Filed: Sep. 20, 2001

(51) Int. Cl. F16J 15/16

(52) U.S. Cl. 277/500

(57) ABSTRACT

The present invention, in one embodiment, provides a low leakage sealing system comprising a pipe for directing the flow of a fluid medium and a housing surrounding the pipe. The housing is spaced radially outward of the pipe defining an annular space. A sealing assembly, comprising an inner seal, outer seal and a final seal are disposed in a spaced relationship in an axial direction in the annular space so as to reduce leakage flow therethrough that is created by the flowing fluid medium pressure. In addition, a ledge is disposed downstream from the sealing assembly and the final seal.

### BACKGROUND OF INVENTION

The present invention relates to a sealing system for steam turbines and particularly relates to a pipe or snout for flowing steam wherein the pipe is sealed to separate casings which have different magnitudes of thermal expansion relative to one another and hence are movable relative to one another and to the pipe.

Steam turbines require sealing systems that can prevent leakage between the steam inlet snout and the surrounding distinct inner and outer shells and a nozzle box (hereafter sometimes collectively referred to as a housing). In current seal designs for this purpose, the seal system consists of sets of rings that seal between the inlet snout and each of the inner and outer shells and nozzle box. For example, for sealing in the annular space between the snout and a shell, a plurality of sealing rings are axially stacked one against the other. Alternate sealing rings in the stack have large and small diameters, respectively. The smaller diameter sealing rings bear and seal against the exterior surface of the pipe or snout, while the larger diameter sealing rings bear and seal against the interior wall surface of the shell. Thus, with the rings alternately sealing radially against the snout and shell walls and sealing axially against one another at opposed axial sealing faces, relative movement between the parts is facilitated.

In one such prior sealing system, the smaller diameter sealing rings have a coefficient of thermal expansion less than the coefficient of thermal expansion of the snout whereby the snout expands a greater amount than the smaller sealing rings to ensure a tight seal between the smaller diameter sealing rings and the snout wall as operating temperatures increase to steady state. In that same prior sealing system, the coefficient of thermal expansion of the larger diameter sealing rings is approximately the same as or larger than the coefficient of thermal expansion of the outer shell such that the larger diameter rings expand more than the shell expands. This ensures a tight seal between the larger diameter sealing rings and the shell wall when the system heats up to operating temperature.

In these prior systems, however, there remain leakage paths due to the relative movement of the various parts of the system, e.g., misalignments and vibrations occur even at operating temperatures. Consequently, the sealing rings may lose contact with one another and/or the interfacing sealing component and yield leakage flow. With axially stacked sealing rings, the leakage flows may occur between the sealing rings and the snout or shell walls, or both, or between the axial sealing faces of the sealing rings per se. Accordingly, there is a need for a low leakage snout sealing system for steam turbines.

### SUMMARY OF INVENTION

The present invention, in one embodiment, provides a low leakage sealing system comprising a pipe for directing the flow of a fluid medium and a housing surrounding the pipe. The housing is spaced radially outward of the pipe defining an annular space. A sealing assembly, comprising an inner seal, outer seal, and a final seal are disposed in a spaced relationship in an axial direction in the annular space so as to reduce leakage flow therethrough that is created by the flowing fluid medium pressure. In addition, a ledge is disposed downstream from the sealing assembly and the final seal.

### BRIEF DESCRIPTION OF DRAWINGS

These and other features, aspects, and advantages of the present invention will become better understood when the following detailed description is read with reference to the accompanying drawings in which like characters represent like parts throughout the drawings, wherein:

FIG. 1 is a side representational view of a steam inlet pipe or snout surrounded by an outer shell, an inner shell and a nozzle box and a sealing system disposed therebetween in accordance with the prior art;

FIG. 2 is an enlarged crossview of a prior art sealing system illustrating axially stacked sealing rings and leakage paths about the sealing rings;

FIG. 3 is a view similar to FIG. 2 illustrating a low leakage sealing system according to one embodiment of the present invention;

FIG. 4 is an enlarged cross-sectional view of FIG. 2 illustrating a low leakage sealing system according to one embodiment of the present invention.

FIG. 5 is a view similar to Figure w illustrating a low leakage sealing system according to another embodiment of the present invention; and

FIG. 6 is a view similar to FIG. 2 illustrating a low leakage sealing system according to another embodiment of the present invention.

### DETAILED DESCRIPTION

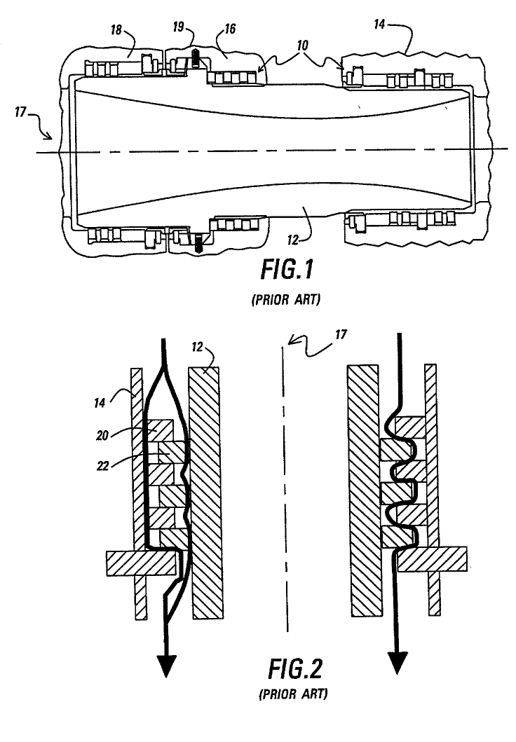

A sealing system, generally designated 10, between a snout or pipe 12 (hereinafter snout) and an outer shell 14, an inner shell 16 and a nozzle box 18, the shell and box being sometimes individually or collectively referred to as a housing 19 (see FIG. 1). These components, disposed around centerline 17, form part of a turbine in which a flowing fluid medium, for example, steam, is passed through the snout 12. It will be appreciated that some turbines operate at high inlet pressures (typically in the range about 3500 psia) thus necessitating the use of at least two separate shells, an inner shell 16 and outer shell 14, nested one inside the other.

A sealing system 10 is required between snout 12 and each of the shells 14 and 16 and nozzle box 18, which are movable relative to one another as the steam turbine, for example, is brought up to operating temperature. In prior sealing systems, a series of axially stacked sealing rings 20 are disposed between the snout 12 and the interior walls of the housing 19. For example, as illustrated in FIG. 2, large and small diameter sealing rings 20 and 22, respectively, are axially stacked one against the other and engage the wall of shell 14, on the one hand, and the outer wall of the snout 12 on the other hand. It will be appreciated, however, that leakage steam flows from the high pressure side toward the low pressure side, i.e., from the top to the bottom of drawing FIG. 2. The leakage paths are thus between the sealing rings 20 and 22 and the walls of the housing, e.g., shell 14 or nozzle box 18, and snout 12 (see FIG. 1). On the rightside of FIG. 2 is illustrated a similar arrangement of sealing rings with a potential leakage path, in which two patterns of leakage (left and right of centerline 17) are shown, between the opposed axial sealing faces of the sealing rings. The potential leakage paths in both the left and right sides of FIG. 2 are illustrated by the heavy, solid black lines.

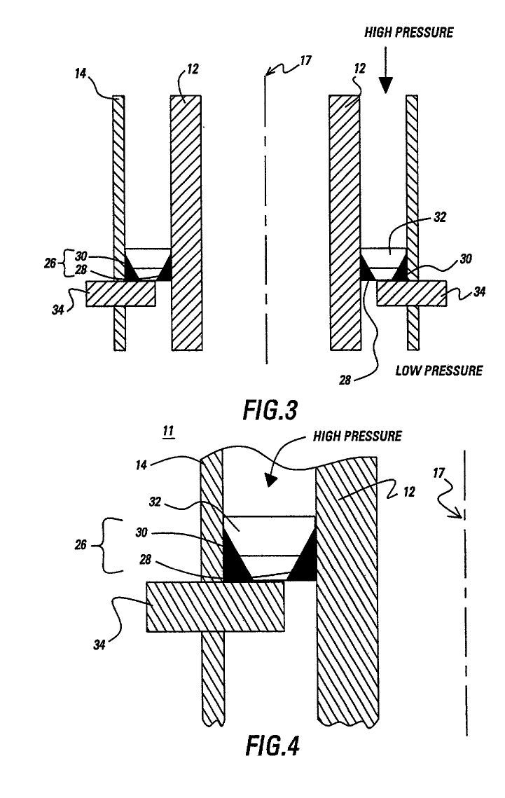

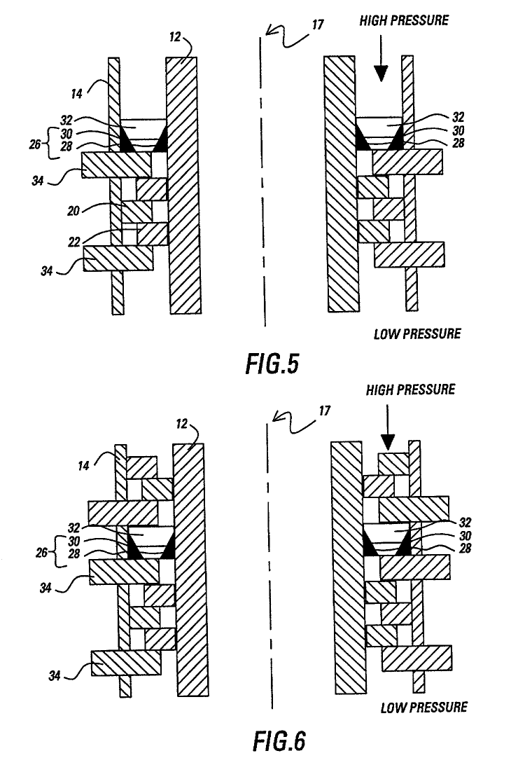

In one embodiment of the present invention shown in FIGS. 3 and 4 (in further detail in FIG. 4), the sealing system of the present invention, generally designated 11, comprises an annular sealing assembly 26 and an annular final seal 32. Sealing assembly 26 and final seal 32 are juxtapositionally disposed so as to be supported axially by at least one support ledge 34. Juxtapositionally disposed means that final seal 32 typically sits radially between inner 28 and outer 30 seal. Sealing assembly 26 comprises an inner seal 28 and outer seal 30 (both generally designated as sealing assembly 26 in the Figures) and is typically supported by a support ledge 34. It will be appreciated that the shape of final seal 32 conforms to the shape of the inner seal 28 and outer seal 30, or in other words, the shape of final seal 32 is adapted to the profile established by the inner seal 28 and outer seal 30. For example, in one embodiment, the trapezoidal shape of final seal 32 conforms to the profile of the inner seal 28, and outer seal 32, at their respective interfaces so that the final seal 32 is disposed against those surfaces as shown in FIG. 4. It will be appreciated that the shape (in cross-sectional view) of sealing assembly 26 and final seal 32 includes, but is not limited to, square, trapezoidal, triangular, circular, rectangular or irregular shapes.

The ledge 34, which is typically disposed downstream from final seal 32 and sealing assembly 26, prevents final seal 32 and sealing assembly 26 from being blown out by the turbine pressure. It will be appreciated that ledge 34 is typically made in segments to facilitate assembly. In operation, when the turbine is pressurized, for example, pressure forces acting on the upstream surface of final seal 32 will drive it between inner seal 28 and outer seal 30 serving to displace inner seal 28 radially inward and displace outer seal 30 radially outward so as to enhance the reduction of leakage flow therebetween. Thus, the upstream pressure against final seal 32 results in a seal being formed resulting in a reduction of leakage flow. Specifically, a reduction of leakage flow exists at the interfaces of the final seal 32 and inner 28 and outer 30 seals, at the interface between inner seal 28 and snout 12, and at the interface between the outer seal 30 and the outer shell 14. It will be appreciated that support ledge 34 may include, but is not limited to, an annular locking ring.

Sealing assembly 26 and final seal 32 materials typically include, but are not limited to, graphite materials, carbon materials and the like. It will be appreciated that such materials may be compressible materials. The constant pressure force during operation of the turbine, for example, will result in the compressible material filling any gaps that may be created due to radial or angular misalignment, wear, or distortion of the parts. It will be appreciated that such materials do not have to be annular and can be in the form of a rope or yarn, for example. The rope can be formed annularly by cutting the rope at angle so as to have overlap between rope ends. In addition, the yarn ends can be interwoven or wrapped to form an annular seal.

In another embodiment, it will be appreciated that sealing system 11 may be combined with at least one existing sealing ring 20 or 22 to create a more robust design (see FIG. 5). For example, sealing system 11 may be placed upstream of the sealing rings 20, 22. Here, sealing system 11 works in conjunction with sealing rings 20, 22 to reduce leakage flow therebetween. It will be appreciated that in any embodiment, more than one sealing system 11 may be used, solely or in combination, with sealing rings 20, 22.

In another embodiment, sealing system 11 may be combined with sealing rings 20, 22 in any order to choke any leakage flow therebetween. It will be appreciated that the number and location of sealing rings 20, 22 and sealing systems 11 may be varied. Here, the combination of sealing system 11 and sealing rings 20, 22 constitutes a reliable design in that, should the sealing rings 20, 22 fail, the sealing system 11 remains in effect to choke any leakage flow therethrough.

It will be apparent to those skilled in the art that, while the invention has been illustrated and described herein in accordance with the patent statutes, modification and changes may be made in the disclosed embodiments without departing from the true spirit and scope of the invention. It is, therefore, to be understood that the appended claims are intended to cover all such modifications and changes as fall within the true spirit of the invention.

1. A low leakage sealing system comprising:
a pipe for directing the flow of a fluid medium;
a housing surrounding said pipe and spaced radially outward of said pipe defining an annular space therebetween;
a sealing assembly, said sealing assembly comprising an inner seal and outer seal;
a final sea, said final seal and said sealing assembly disposed in a spaced relationship in an axial direction in said annular space so as to reduce leakage flow therethrough created by said flowing fluid medium pressure; and
at least one ledge disposed downstream from said sealing assembly and said final seal.

2. A sealing system according to claim 1, wherein said fluid medium is a heated fluid medium.

3. A sealing system according to claim 1, wherein said sealing assembly comprises graphite, carbon, or a mixture thereof.

4. A sealing system according to claim 1, wherein said final seal comprises graphite, carbon or a mixture thereof.

5. A sealing system according to claim 1, wherein the cross-sectional shape of said final seal is adapted to the profile established by said sealing assembly.

6. A sealing system 10 according to claim 1, wherein said final seal is disposed such that upstream pressure on said final seal serves to force said inner seal in a radially inwardly direction and force said outer seal in a radially outward direction.

7. A sealing system according to claim 1, wherein said low leakage sealing system is disposed adjacent to at least one sealing ring.

8. A sealing system according to claim 1, wherein said ledge is disposed so as to provide a support surface for said sealing assembly and said final seal.

9. A low leakage sealing system for a turbine, comprising:
a pipe for directing the flow of a heated fluid medium;
a housing 19 surrounding said pipe and spaced radially outward of said pipe defining an annular space therebetween;
a final seal disposed in said annular space;
a sealing assembly, said sealing assembly comprising an inner seal and outer seal, disposed downstream from said final seal in said annular space; and
wherein said final seal and said sealing assembly are disposed in a spaced relationship in an axial direction and are subject to said flowing fluid medium pressure that acts on said final seal and said sealing assembly;
at least one ledge disposed downstream from said sealing assembly and said final seal.

10. A sealing system according to claim 9, wherein said sealing assembly comprises graphite, carbon, or a mixture thereof.

11. A sealing system according to claim 9, wherein said final seal comprises graphite, carbon or a mixture thereof.

12. A sealing system according to claim 9, wherein the cross-sectional shape of said final seal is adapted to the profile established by said sealing assembly.

13. A sealing system according to claim 9, wherein said final seal is disposed such that upstream pressure on said final seal serves to force said inner seal in a radially inwardly direction and force said outer seal in a radially outwardly direction.

14. A sealing system according to claim 9, wherein said low leakage sealing system is disposed adjacent to at least one sealing ring.

15. A sealing system according to claim 9, wherein said ledge is disposed so as to provide a support surface for said sealing assembly and said final seal.
